(19) United States
(12) Patent Application Publication
(10) Pub. No.: US 2006/0168561 A1
(43) Pub. Date: Jul. 27, 2006

(54) Method and apparatus for enabling live selection of content for print on demand output

(75) Inventor: Jeff Wood, Brunswick, OH (US)

Correspondence Address: Law Offices of John D. Gugliotta, PE, Esq., 202 Delaware Building, 137 South Main Street, Akron, OH, 44308, US

(73) Assignee: Integrated Marketing Technologies Inc.

(21) Appl. No.: 11/041,110

(22) Filed: Jan. 24, 2005

(51) Int. Cl. G06F 9/44

(52) U.S. Cl. 717/109

(57) ABSTRACT

A system is provided for allowing collaborative, web-enabled design of content for print on demand output. Categories of standardized products are provided, and upon selection of any particular product type a designer's choice will be utilized as a default which incorporates design selection categories including backgrounds, graphics, products, text boxes, headlines, logos, and text elements capable of manipulation. Previews are displayed in live, real time images incorporate low resolution equivalents of the final images. These low resolution images suffice for design decision, and allow such decisions to be communicated over the Internet(™) by any number of authorized users. At each element selection, as the preview is displayed so are selection thumbnails. Selection of alternate elements cause the preview to become interactive with the user, allowing true live manipulation of the active element(s). Position, content, and display elements can all be made active parameters. As this layered menu system is navigated, a final low resolution design can be completed and be available on-line for approval and selection. Once selected, the low-resolution equivalent is used to construct a full size, high resolution electronic document distribution format and, eventually, to a print ready design for transfer to print-on-demand production through conversion to a standard print format output.

### RELATED APPLICATIONS

There are no previously filed, nor currently any co-pending applications, anywhere in the world.

### BACKGROUND OF THE INVENTION

1. Field of the Invention

The present invention relates generally to systems for providing web-enabled design of content for print output and, more particularly, to a method for providing both true live manipulations of elements at the user interface, as well as enabling such print output to be print-on-demand capable.

2. Description of the Related Art

As is well known in the art, the ability to provide web-enabled collaborative design exists to allow various users to provide group creative control over content design. For example, in the field of providing point of service printed display elements, conventional systems solve print communication problems by a generally two step process: first, design is completed by ad agencies, graphic design firms, event marketing firms, promotional marketing firms, print brokers, commercial printers or the like; second, with approval from the client, the print design is forwarded to a print industry supplier for production fulfillment. Using the food service distribution industry as an example, this has been the conventional method of producing everything from sign, to posters, to menus, to table tents, to wait staff cards, and so on.

Such as system has many drawbacks, the most obvious of which are the delays between the design and production phases, as well as the cost and supply limitations that are placed on production of inventory. If many printed pieces are made, the unit cost is low, but the amount of inventory and design changeover costs high. However, to obtain quickly adaptable changes in printed content (seasonal, pricing, specials, etc.) the user loses quantity of scale pricing.

Because of such system drawbacks, the industry desire and trend is to migrate toward greater ability to provide print-on-demand content. This creates shorter turnaround times, allowing users to be more dynamic with their marketing, and eliminates the need for carrying significant print product inventory. Continuing to use the food service distribution industry as an example, the migration to print on demand product can allow banners, brochures, case cards, menus, posters, table tends or wait staff cards to be quickly and easily changed, modified, and updated, both with selections and descriptions as well as with price or seasonality.

Additional opportunities are created within the industry in the design stage. Collaborative design processes can now include timely input from the point of purchase in making design selections. For example, each individual restaurant proprietor of a large national chain can provide direct input into their individual facilities selections, specials and pricing in addition to the regional or national marketing management of the chain.

A search of the prior art did not disclose any patents that read directly on the claims of the instant invention; however, of considerable relevance is the Instant Impact(™) system provided by Centiv. While such a system can allow for collaborative input into print layout design which is incorporated into this invention in combination, among other differences such a system does not allow for true live manipulation of elements at a web-enabled user interface, but rather requires a proof ‘redraw’ each time changes are made to content elements or element locations.

Consequently, a need has been felt for providing an apparatus and method of providing both true live manipulations of elements at the user interface, as well as enabling such print output to be print-on-demand capable.

### SUMMARY OF THE INVENTION

It is therefore an object of the present invention to provide a method for providing web-enabled design of content for print output.

It is a feature of the present invention to provide a method for providing both true live manipulations of elements at the user interface, as well as enabling such print output to be print-on-demand capable

Briefly described according to one embodiment of the present invention, a system is provided for allowing collaborative, web-enabled design of content for print on demand output. Categories of standardized products are provided, and upon selection of any particular product type a designer's choice will be utilized as a default which incorporates design selection categories including backgrounds, graphics, products, text boxes, headlines, logos, and text elements capable of manipulation. The addition of customized logos is also anticipated. Previews are displayed in live, real time images incorporate low resolution equivalents of the final images. These low resolution images suffice for design decision, and allow such decisions to be communicated over the Internet(™) by any number of authorized users. At each element selection, as the preview is displayed so are selection thumbnails. Selection of alternate elements cause the preview to become interactive with the user, allowing true live manipulation of the active element(s). Position, content, and display elements can all be made active parameters. As this layered menu system is navigated, a final low resolution design can be completed and be available on-line for approval and selection. Once selected, the low-resolution equivalent is used to construct a full size, high resolution electronic document distribution format and, eventually, to a print ready design for transfer to print-on-demand production through conversion to a standard print format output.

In accordance with a preferred embodiment, centralized control of brand, logo, placement and representation can be maintained within predefined limits, while allowing for customization of individual content and location.

Further, the present invention is it is readily adaptable to a number of products, organizations and users within the supply chain.

An advantage of the present invention is that it shortens the lead time between design and production fulfillment.

Another advantage of the present invention is that it reduces costs of printing large volume batches.

Further, a preferred embodiment of the present invention can empower more creativity and content to the point of purchase or point of supply.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a product category selection menu for an interactive design method for print on demand output according to one embodiment of the present invention;

FIG. 2 is a product selection style menu 20 for use therewith;

FIG. 3 is an interactive design selection menu 30 for use therewith;

FIG. 4 is an exploded perspective schematic of a designer's choice 32 as produced by the interactive design selection menu 30 of FIG. 3;

FIG. 5 is a background selection menu 50 for use therewith;

FIG. 6 is a products selection menu 60 for use therewith;

FIG. 7 is a headline selections menu 70 for use therewith;

FIG. 8 is a logo selection menu 80 for use therewith;

FIG. 9 is a text selections editor 90 for use therewith;

FIG. 10 is a flow diagram showing sue of an interactive design method for print on demand output according to the present invention;

FIG. 11 is an alternate style of providing product category selection menu to replace those style shown in FIG. 1;

FIG. 12 is an alternate style of providing product selection style menus to replace those style shown in FIG. 2;

FIG. 13 is an alternate style for a system welcome screen; and

FIG. 14 is an alternate list of individual product categories item selections to replace those styles shown in FIG. 1-2.

### DESCRIPTION OF THE PREFERRED EMBODIMENTS

In order to describe the complete relationship of the invention, it is essential that some description be given to the manner and practice of functional utility and description in the context of a particular application.

The best mode for carrying out the invention is presented in terms of its preferred embodiment applied to a particular field of use, herein depicted within the Figures as print based selling tools for the food service industry

1. Detailed Description of the Figures

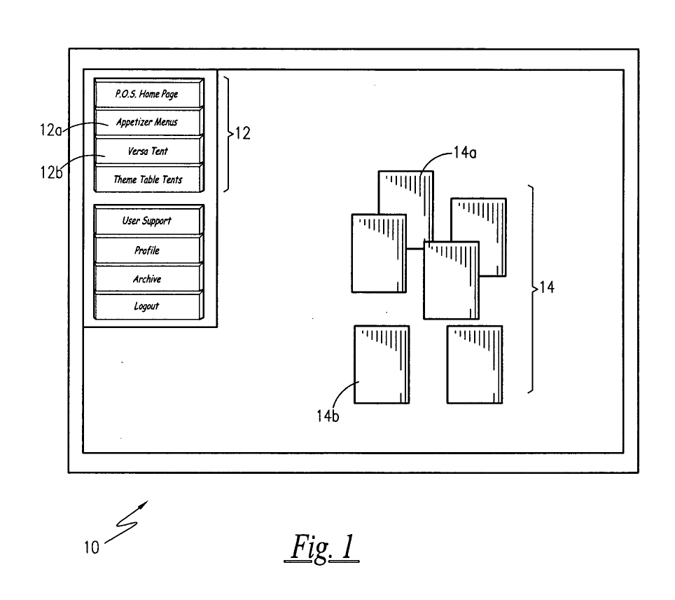

Referring now to FIG. 1, a product selection menu 12 for an interactive design method for print on demand output 10 is provided according to one embodiment of the present invention. The product category selection menu 12 is anticipated as being alternately or conjunctively supported in a more graphical fashion by use of product category selection icons 14, including a first product selection icon 14a that corresponds with a first product selection menu item 12a, a second product selection icon 14b that corresponds with a second product selection menu item 12b, and so forth. It is anticipated that the determination of the type and number of product selections can be adapted and customized to satisfy any particular organization, industry, or supply chain element. In the food service distribution industry, such product selections can include banners, bottle-neckers, brochures, case cards, case talkers, coasters, combo cards, coupons, header cards, hutch cards, menus, menu cards, posters, recipe booklets, sell sheets, shelf talkers, static clings, stickers, table tents and wait staff cards.

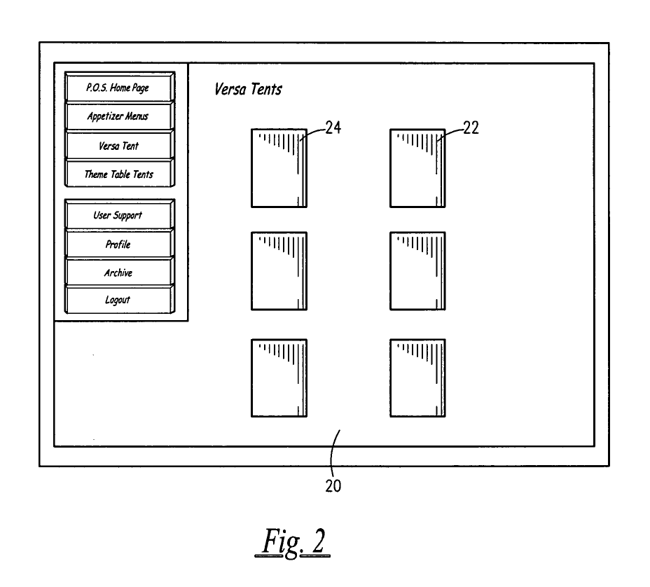

Upon selection of a product selection icon 14a or product selection menu item 12a, a product selection menu 20 is provided as shown in FIG. 2. Shown here are a plurality of style selection icons. A first style selection icon 22 will allow the user to manipulate design elements within the overall parameters set for a first style of this particular product category; a second style selection icon 24 will allow the user to manipulate design elements within the overall parameters set for a second style of this particular product category, and so on.

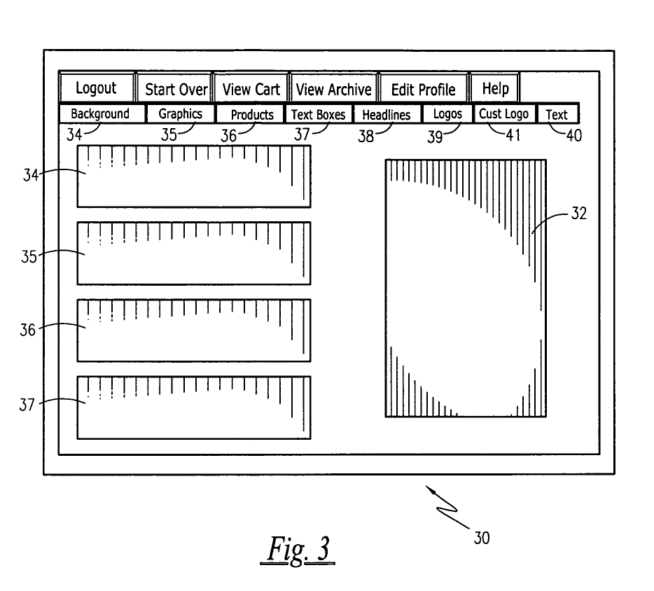

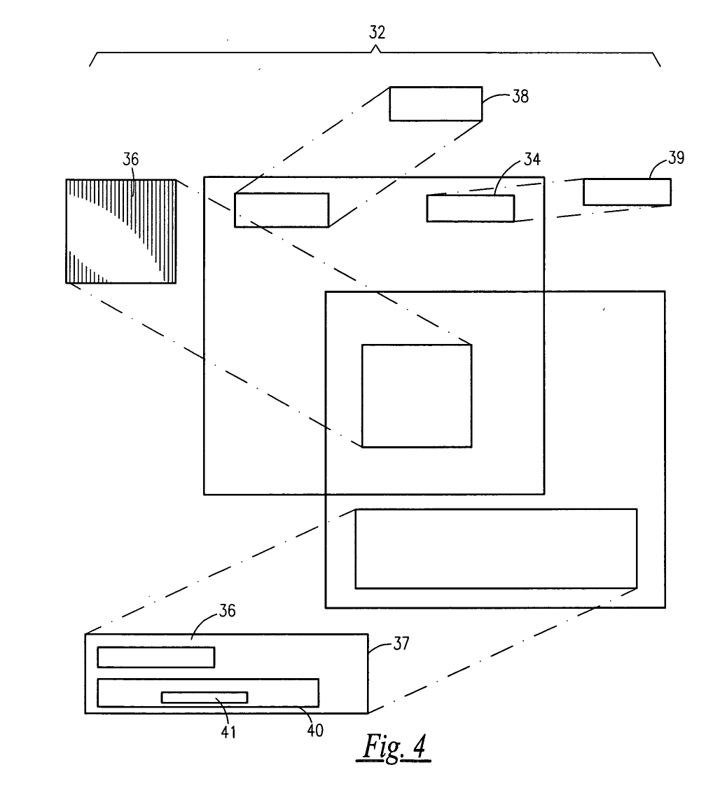

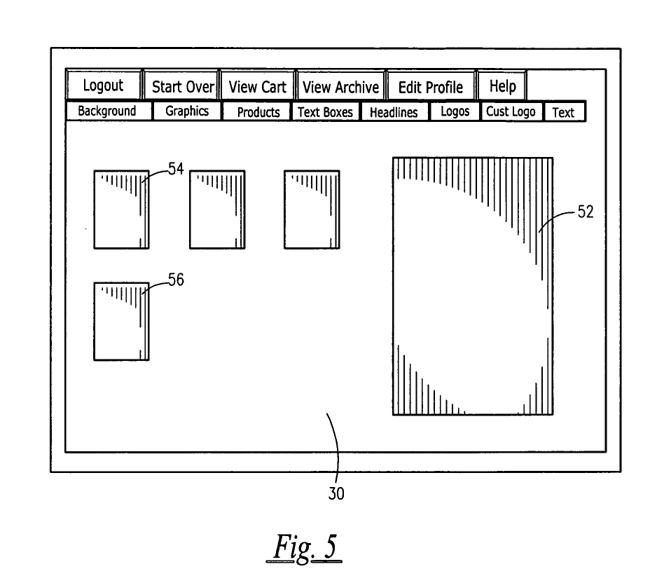

FIG. 3 shows the interactive design selection menu 30 for one particular style selection. At this system level, a designer's choice 32 is displayed as a default which incorporates a default design selection for each of the design selection categories including backgrounds 34, graphics 35, products 36, text boxes 37, headlines 38, logos 39, and text elements 40 capable of individual manipulation. The addition of customized logos 41 is also anticipated. In conjunction with FIG. 4, an exploded perspective schematic of this designer's choice 32 is shown as produced by the interactive design selection menu 30. In this particular example, the backgrounds 34 provides a selection of various approved background graphics, designs, colors, or shadings that can be used to replace the background 34 of the default image embodied by the designer's choice 34. Upon selection of an alternate background design, the user can then preview the completed style incorporating all defaults, but replacing the default background selection with the user's new selection. As an example, FIG. 5 shows a background selection menu 50 implemented upon selection of the background design selection category 34. Previews 52 are displayed in live, real time images incorporate low resolution equivalents of the final images. These low resolution images suffice for design decision, and allow such decisions to be communicated over the Internet(™) by any number of authorized users. A plurality of background selections, such as a first background selection 54, second background selection 56, and so on provide thumbnail selections of each background element selections. Similarly, the graphics 36 category can allow the user to add or change graphics such as objects within or borders around the image. Selection of alternate elements cause the preview 52 to become interactive with the user, allowing true live manipulation of the active element(s).

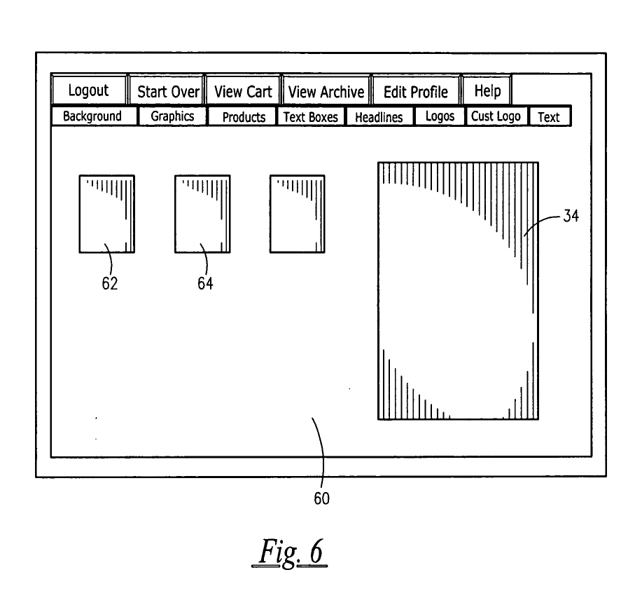

In an additional example shown in FIG. 6, the products category selection 36 provides a selection of various approved product images that can be used to replace the product image 36 of the default image embodied by the designer's choice 34. Upon selection of a first product image 62, a second product image 64, or similar alternate product selection, the user can then preview the completed style incorporating all defaults, but replacing the default product shot selection with the user's new selection.

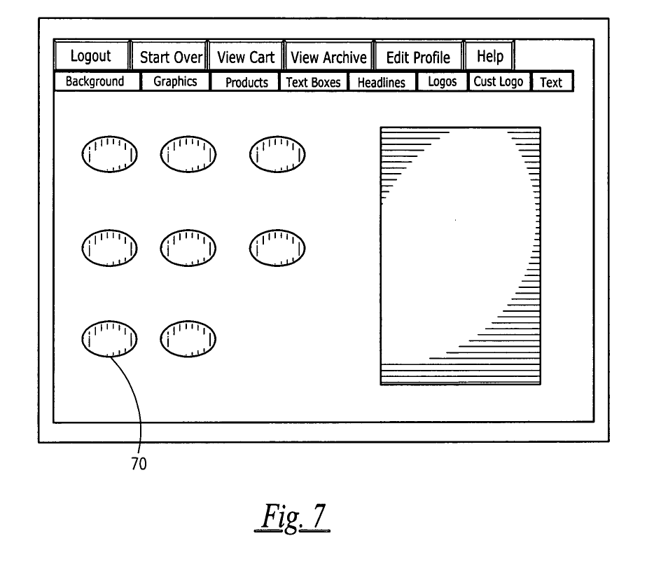

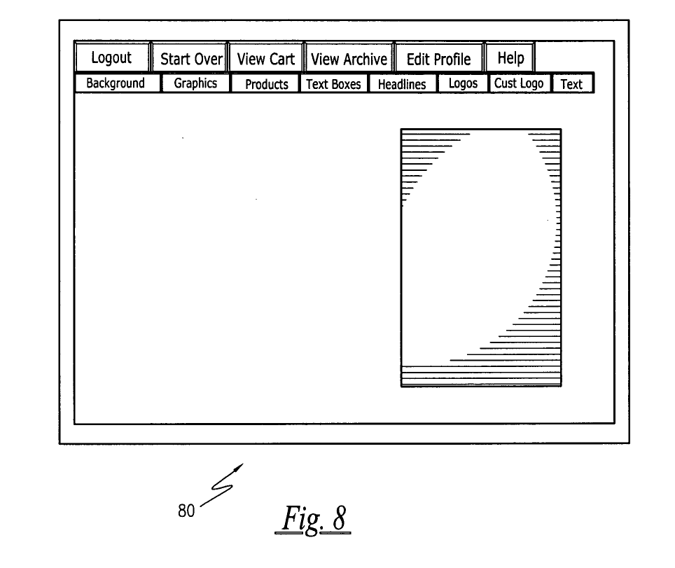

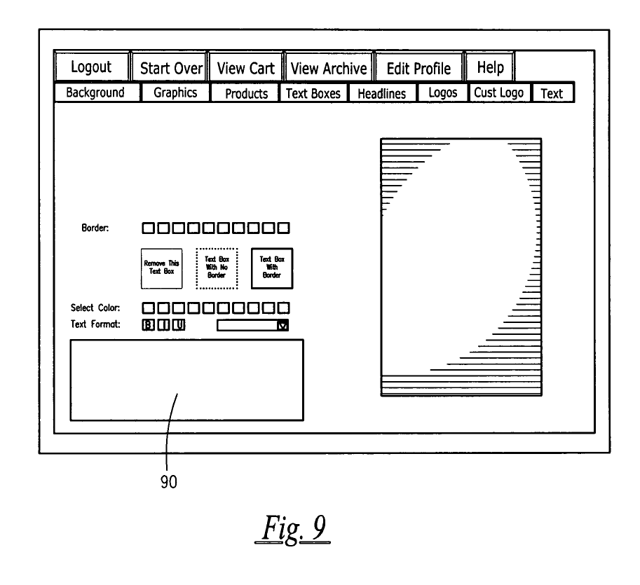

As the user steps through the various design selection categories, text boxes 37 allows the addition, removal or changing of framed boxes to enhance the product text 40 (FIG. 9), headlines 38 (FIG. 7) to add predefined headline text or titles 70, or logos 39 (FIG. 8) to add brand or supplier logo thereto.

At each design selection step, previews 52 are displayed in live, real time images incorporate low resolution equivalents of the final images. These low resolution images suffice for design decision, and allow such decisions to be communicated over the Internet(™) by any number of authorized users. Selection of alternate elements cause the preview 52 to become interactive with the user, allowing true live manipulation of the active element(s). In accordance with a preferred embodiment, centralized control of brand, logo, placement and representation can be maintained within predefined limits, while allowing for customization of individual content and location.

Position, content, and display elements can all be made active parameters. As this layered menu system is navigated, a final low resolution design can be completed and be available on-line for approval and selection. Once selected, the low-resolution equivalent is used to construct a full size, high resolution electronic document distribution format and, eventually, to a print ready design for transfer to print-on-demand production through conversion to a standard print format output.

2. Operation of the Preferred Embodiment

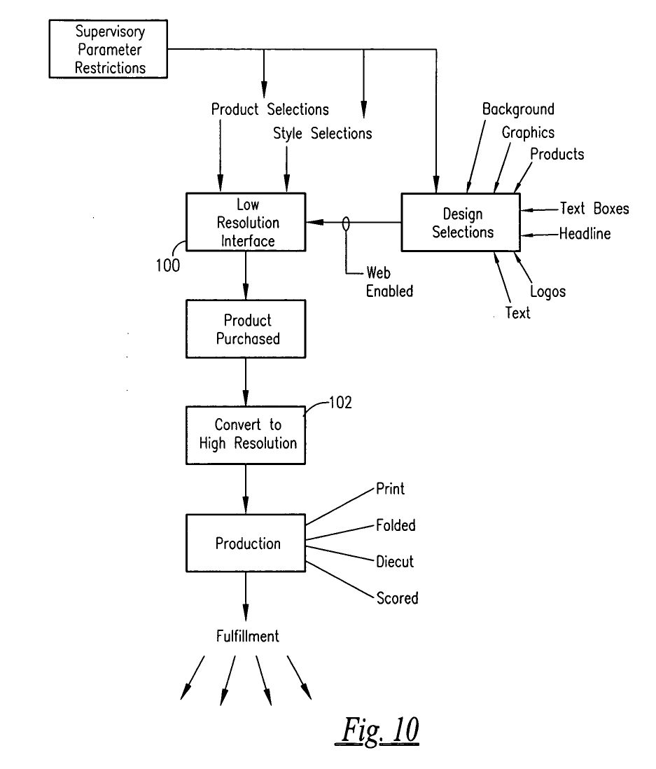

In accordance with a preferred embodiment of the present invention, as shown in FIG. 10, supervisory parameter restrictions are determined as to which product selections are available, which style selections are allowed, what backgrounds, graphics, products, headlines and logos can be utilized. The design selection process is then implemented to form a low resolution interface 100. Position, content, and display elements can all be made active parameters. As this layered menu system is navigated, a final low resolution design can be completed and be available on-line for approval and selection. Once selected, the low-resolution equivalent is used to construct a full size, high resolution electronic document distribution format 102 and, eventually, to a print ready design for transfer to print-on-demand production through conversion to a standard print format output. Production can be performed, as necessary, by printing, folding, die cutting, scoring, or otherwise producing the print advertising material. Because customization of the quantity and type of products, and content of each, multi-point distribution can be requested and delivered in order to distribute channel specif content to the individual distribution channel.

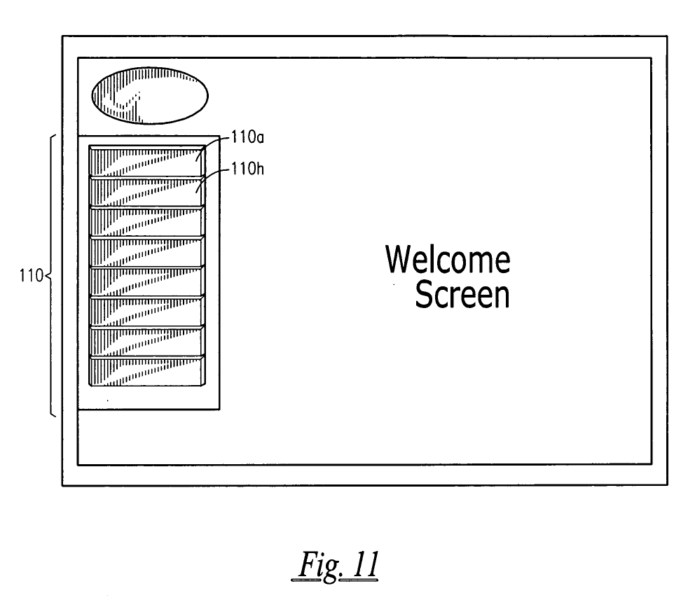

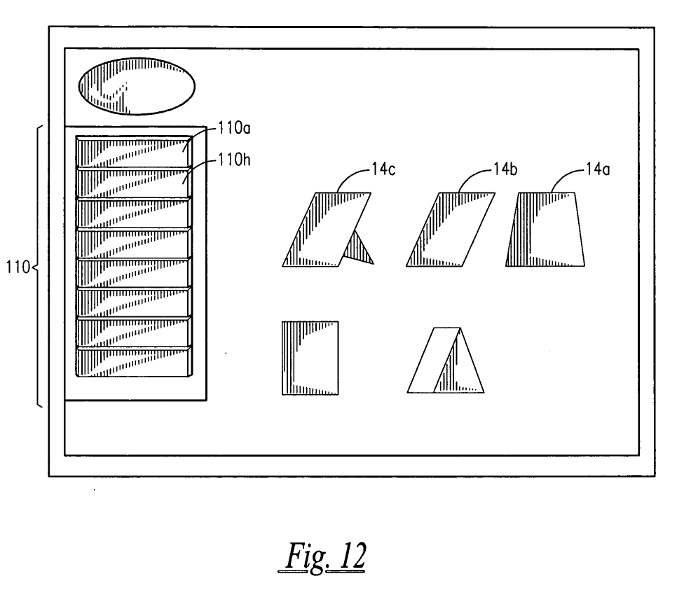

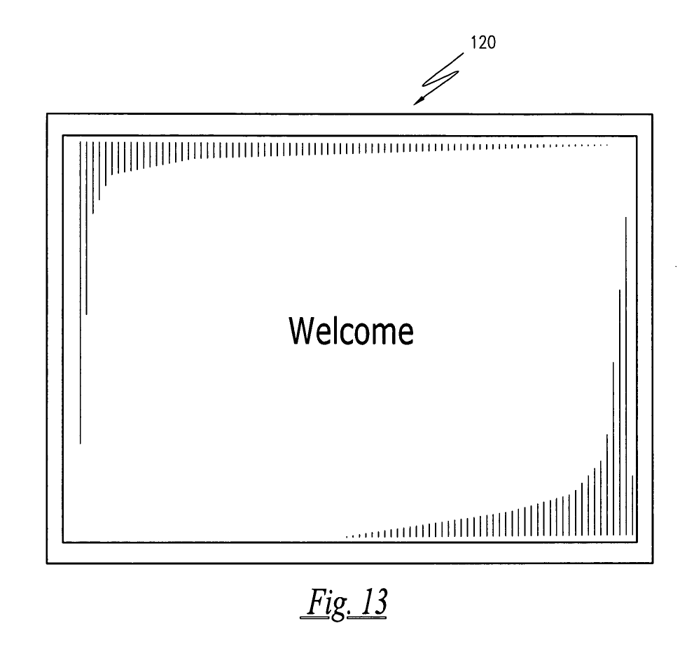

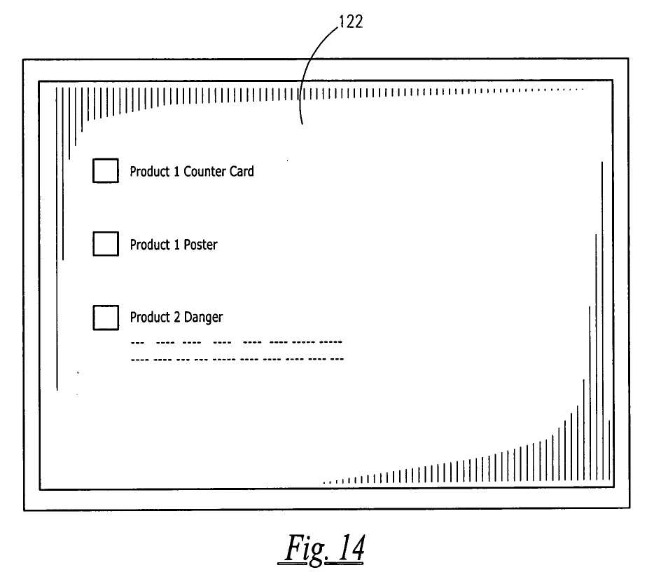

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. By way of example, and not as a limitation, the present system is intended to be easily adapted to any industry utilizing sell sheets, posters, banners, or other printed advertising matter and having multiple distribution channels. Further still, it is envisioned that there are a number of ways of presenting the products or process in a way that can be customized for or made more intuitive to the individual user. For example, FIG. 11 and FIG. 12 show an alternate style of providing product category selection menus and product selection style menus to replace those style shown in FIGS. 1 and 2. In this style, a retail item selection menu 110 is first provided for listing individual retail items, shown as 110a, 110b, etc. For a user that has a retail products in diverse and unrelated fields, this method of guiding the user through the customization process can form a better guide. After selection of an individual retail item 110a, 110b, etc., then the product category selection icons 14a, 14b, 14c et cetera, are presented in the type and number of product selections can be adapted and customized to satisfy any particular organization, industry, or supply chain element, such as menu cards 14a, danglers 14b, counter cards 14c, or any of the other banners, bottle-neckers, brochures, case cards, case talkers, coasters, combo cards, coupons, header cards, hutch cards, menus, menu cards, posters, recipe booklets, sell sheets, shelf talkers, static clings, stickers, table tents and wait staff cards that were previously disclosed. Yet another style is presented in FIG. 13 and FIG. 14, in which after entering the welcome screen 120 a user is taken directly to a list of individual product categories item selections 122. Such a method is anticipated as listing the individual product category selections for specific retail items, rather than stepping through a series of narrowing selections.

Because of such stylistic variations capable for enabling the current invention, it is intended that the scope of the invention be defined by the Claims appended hereto and their equivalents. Therefore, the scope of the invention is to be limited only by the following claims.

What is claimed is:

1. A method for collaborative, web-enabled design of content for print on demand output, said method comprising the steps
a. Providing categories of standardized product types for selection;
b. Upon selection of any particular product type, providing a default template which incorporates design selection categories capable of manipulation;
c. Allowing a user to change or manipulate a design element in any said design selection category;
d. Previewing the maniplated template in live, real time images incorporate low resolution equivalents of the final images;
e. Repeating step c-d as needed;
f. Providing a final low resolution image of the completed design for final approval;
g. Once approved, using the low-resolution image to construct a full size, high resolution electronic document distribution format; and,
h. Create a print ready design for transfer to print-on-demand production through conversion to a standard print format output.

2. The method as recited in claim 1, wherein said design selection categories are selected from the group comprising: backgrounds; graphics; products; text boxes; headlines; logos; customized logos; and text elements.

3. The method as recited in claim 1, wherein said low resolution preview images suffice for design decision, and allow such decisions to be communicated over the Internet(™) by any number of authorized users.

4. The method as recited in claim 3, wherein selection of alternate elements cause the preview to become interactive with the user, allowing true live manipulation of the active element(s).

5. The method as recited in claim 1, wherein position, content, and display elements can all be made active parameters.

6. The method as recited in claim 1, wherein said categories of standardized product types is provided by a product category selection menu supported in a graphical fashion by use of product category selection icons.

7. The method as recited in claim 6, wherein said standardized product types are selected from the group comprising: banners; bottle-neckers; brochures; case cards; case talkers; coasters; combo cards; coupons; header cards; hutch cards; menus; menu cards; posters; recipe booklets; sell sheets; shelf talkers; static clings; stickers; table tents; and wait staff cards.

8. The method as recited in claim 4, wherein at each design selection step, previews are displayed in live, real time images incorporate low resolution equivalents of the final images and selection of alternate elements cause said preview to become interactive with the user, allowing true live manipulation of the active element(s).

9. The method as recited in claim 1, wherein said template allows for centralized control of brand, logo, placement and representation can be maintained within predefined limits, while allowing for customization of individual content and location.

10. The method as recited in claim 1, wherein the design is initiated by a web browser.

11. An apparatus for enabling live selection of content for print on demand output comprising:
a. Web-enabled access for inputation and review of a design element selection in a design selection category;
b. Means for presenting a low resolution preview images sufficient for design decision, and allow such decisions to be communicated over the Internet(™) by any number of authorized users;
c. Means for converting a low-resolution image to construct a full size, high resolution electronic document distribution format; an
d. Means for creating a print ready design for transfer to print-on-demand production through conversion to a standard print format output.

12. The apparatus of claim 11, wherein communication between said low-resolution image and said print ready design is accomplished over the Internet(™).
